(19) United States
(12) Patent Application Publication
(10) Pub. No.: US 2009/0226779 A1
(43) Pub. Date: Sep. 10, 2009

(54) Fuel Cell System

(75) Inventor: Hiroki Ohkawara, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/719,818

(22) PCT Filed: Nov. 21, 2005
(86) PCT No.: PCT/JP05/21374

§ 371 Date: May 21, 2007

(30) Foreign Application Priority Data
Nov. 25, 2004 (JP) 2004-341228

(51) Int. Cl. H01M 8/06; H01M 8/04

(52) U.S. Cl. 429/19; 429/24

(57) ABSTRACT

To provide a fuel cell system which is capable of replenishing water for reserved hot water from a high-pressure water source, without inviting increases in cost and dimension.

In the fuel cell system, an FC cooling water circulation circuit 73 is provided independently of a reserved hot water circulation circuit 72, and a first heat exchanger performs heat exchange between the reserved hot water and first heating medium. Further, a condensing refrigerant circulation circuit is also provided independently of the reserved hot water circulation circuit 72, and a second heat exchanger 76 performs heat exchange between the reserved hot water and second heating medium. That is, the reserved hot water is not subjected to direct heat exchange with anode offgas, cathode offgas, combustion exhausted gas and reforming gas, but is subjected to indirect heat exchange therewith through the second heat exchanger 76.

### TECHNOLOGICAL FIELD

The present invention relates to a fuel cell system having a fuel cell, a reformer for generating fuel gas to be supplied to the fuel cell, a reserved hot water tank for storing reserved hot water and a reserved hot water circulation circuit for circulating the reserved hot water.

### BACKGROUND ART

As fuel cell system there has been well-known one which is provided with a fuel cell, a reformer for generating fuel gas to be supplied to the fuel cell, a reserved hot water tank for storing reserved ho water and a reserved hot water circulation circuit for circulating the reserved hot water, wherein waste heats generated from the fuel cell and the reformer are collected on the reserved hot water circulation circuit to heat the reserved hot water.

As one type of the aforementioned fuel cell system, there is known one which is described in Patent Document 1“Fuel Cell Power Generation System”. As shown in FIG. 1 of the Patent Document 1 the fuel cell power generation system 10 is provided with a heat exchange medium circulation passage 50 which circulates heat exchange medium 54 water or hot water). The heat exchange medium circulation passage 50 is such a circulation passage that the heat exchange medium 54 reserved in a reserved hot water tank 52 passes from this reserved hot water tank 2 through an anode offgas heat exchanger 42, a cathode offgas heat exchanger 44 and a combustion exhaust gas heat exchanger 45 and a cooing water heat exchanger 46 and again returns to the reserved hot water tank 52. The anode offgas heat exchanger 42 collects through the heat exchange medium 54 the heat of anode offgas exhausted from an anode, the cathode offgas heat exchanger 44 collects through the heat exchange medium 54 the heat of cathode offgas exhausted from a cathode, the combustion exhaust gas heat exchanger 45 collects the heat of combustion exhaust gas through the heat exchange medium 54, and the cooling water heat exchanger 46 collects through heat exchange medium 54 the heat of cooling water flowing along a cooling water circulation passage 43 which go through an initial offgas heat exchanger 58 and an initial offgas burner 57.

Further, as another type, there has been known one which is disclosed in Patent Document 2 “Fuel Cell Power Generation System”. As shown in FIG. 1 of Patent Document 2, the fuel cell power generation system 20 has arranged a line wherein water from a cold water pipe 54 connected to the bottom of a reserved hot water tank 52 is returned to the top of the reserved hot water tank 52 by way of a radiator 42, a cooler 48b for cooling an inverter 48a, a condenser 38, a heat exchanger 36, and a hot water pipe 56. The heat exchanger 36 is incorporated in a circulation flow passage (the circulation flow passage shown by the broken line in the figure) for a refrigerant (cooling water or the like) for a fuel cell stack 34 and cools the refrigerant.

Further, as another type, there has been known one which is described in Patent Document 3 “Solid Polymer Type Fuel Cell Power Generating Device”. As shown in FIGS. 1-3 of Patent Document 3, the solid polymer type fuel cell power generation device GS1 has a heat exchanger HEX further arranged behind a heat exchanger 32 for an exhaust line 31, a heat exchanger 46 for an exhaust line 45 and a heat exchanger 71 for gas exhausted from an air electrode (k) of a fuel cell 6, and a line L1 is provided for heat-exchangeably circulating and feeding hot water A, which has collected waste heat by feeding water in the reserved hot water tank 50 by a pump P through the heat exchange HEX to the heat exchangers 71, 32 and 46, directly to a water tank 21. A line L2 is provided in para a for feeding the hot water A to the reserved hot water tank 50 where the hot water A is not needed to be fed to the water tank 21 by way of the line L1. The cooling water which is caused by pump 48 to circulate through a cooler section 6c of the fuel cell 6 flows into the water tank 21 through a water pipe 73.

Patent Document 1: Japanese unexamined, published patent application No. 2003-257457 (Pages 4-7 and FIG. 1)
Patent Document 2: Japanese unexamined, published patent application No. 2004-111209 (Pages 4-6 and FIG. 1)
Patent Document 3: Japanese unexamined published patent application No. 2002-216819 (Pages 2-6 and FIGS. 1-3)

### DISCLOSURE OF THE INVENTION

### Problem to be Solved by the Invention

In the fuel cell power generation system described in the aforementioned Patent Document 1, where the reserved hot water tank 52 is of a sealed type that tap water is replenished directly thereto, the tap water pressure being a high pressure is exerted on the reserved hot water tank 52 and the heat exchange medium circulation passage 50, and this tap water pressure is exerted also on the anode offgas heat exchanger 42, the cathode offgas heat exchanger 44, the combustion exhaust gas heat exchanger 45 and the cooling water heat exchanger 46. From this fact, it is desirable to make the anode offgas heat exchanger 42, the cathode offgas heat exchanger 44 the combustion exhaust gas heat exchanger 45 take a pressure-resistive structure, but so doing gives rise to a problem resulting in high cost and a large dimension.

In the fuel cell power generation system described in the aforementioned Patent Document 2 and the solid polymer type fuel cell power generating device described in the aforementioned Patent Document 3, there arises the same problem as in the fuel cell power generation system described in the aforementioned Patent Document 1.

The present invention has been made for solving the aforementioned various problem, and an object thereof is to provide a fuel cell system capable of replenishing water for reserved hot water from a high-pressure water source without involving increase in cost and dimension.

### Measures for Solving the Problem

In order to solve the aforementioned problems, the structural feature of the invention according to Claim 1 resides in a fuel cell system, which comprises a fuel cell a reformer for generating fuel gas to be supplied to the fuel cell, a reserved hot water tank for reserving reserved hot water and a reserved hot water circulation circuit for circulating the reserved hot water, wherein waste heats generated in the fuel cell and the reformer are collected on the reserved hot water circulation circuit to heat the reserved hot water the system further comprising a heating medium circulation circuit provided independently of the reserved hot water circulation circuit for circulating heating medium which has collected at least either the waste heat of offgas exhausted from the fuel cell or the waste heat generated in the reformer and the waste heat generated through the power generation by the fuel cell, and a heat exchanger for performing heat exchange between the reserved hot water and the heating medium.

Further, the structural feature of the invention according to Claim 2 resides in that in Claim 1, at east either one of the reserved hot water circulation circuit and the heating medium circulation circuit is provided with cooler mean for cooling fluid.

Further, the structural feature of the invention according to Claim 3 resides in that in Claim 1 or Claim 2, at least either one of the reserved hot water circulation circuit and the heating medium circulation circuit is provided with a bypath passage for bypassing the heat exchanger.

Further, the structural feature of the invention according to Claim 4 resides in that in Claim 1, the heating medium circulation circuit is composed of either one of a first heating medium circulation circuit for circulating first heating medium having collected the waste heat generated through the power generation by the fuel cell and a second heating medium circulation circuit for circulating second heating medium having collected at least either one of the waste heat of offgas exhausted from the fuel cell and the waste heat generated in the reformer, and that the heat exchanger is composed of at least either one of a first heat exchanger for performing heat exchange between the reserved hot water and the first heating medium and a second heat exchanger for performing heat exchange between the reserved hot water and the second heating medium.

Further, the structural feature of the invention according to Claim 5 resides in that in Claim 4, the second heating medium circulation circuit is provided thereon with a condenser for collecting heat from high temperature, steam-impregnating gas which circulates through the reformer and the fuel cell, and for condensing the steam and that the second heating medium is condensing refrigerant which circulates through the condenser.

Further, the structural feature of the invention according to Claim 6 resides in that in Claim 4, at least any one of the reserved hot water circulation circuit and the first and second heating medium circulation circuits is provided with cooler means for cooling fluid.

Further, the structural feature of the invention according to Claim 7 resides in that in any one of Claims 4 to 6, at least either one of the reserved hot water circulation circuit and the second heating medium circulation circuit is provided with a bypath passage for bypassing the second heat exchanger.

Further, the structural feature of the invention according to Claim 8 resides in that in any one of Claims 4 to 6, at least any one of the reserved hot water circulation circuit and the first heating medium circulation circuits is provided with a bypath passage for bypassing the first heat exchanger.

Further, the structural feature of the invention according to Claim 9 resides in that in Claim 1 the heating medium circulation circuit is one circulation circuit for circulating the heating medium which collects the waste heat generated through the power generation by the fuel cell and which also collects at least one of the waste heat of the offgas exhausted from the fuel cell and the waste heat generated in the reformer and that the heat exchanger performs heat exchange between the reserved hot water and the heating medium.

Further the structural feature of the invention according to Claim 10 resides in that in Claim 9, at least one of the reserved hot water circulation circuit and the heating medium circulation circuit is provided with cooler means for cooling fluid.

Further the structure feature of the invention according to Claim 11 resides in that in Claim 9 or Claim 10, at east either one of the reserved hot water circulation circuit and the heating medium circulation circuit is provided with a bypath passage for bypassing the heat exchanger.

Further, the structural feature of the invention according to Claim 12 resides in that in any one of Claims 1 to 11, there are provided reserved hot water tank out et temperature detecting means provided on the reserved hot water circulation circuit for detecting the temperature of the reserved hot water outflowing from an outlet of the reserved hot water tank, first power generation output limit value deriving means for deriving a power generation output limit value based on the reserved hot water tank outlet temperature detected by the reserved hot water tank outlet temperature detecting means and a first map or calculation expression representing the correlation between the reserved hot water tank outlet temperature and the power generation output limit value for the fuel cell, and first power generation controlling the power generation output of the fuel cell in dependence on the power generation output limit value derived by the first power generation output limit value deriving means.

Further, the structural feature of the invention according to Claim 13 resides in that in Claims 12, the first power generation control means comprises user load electric power detecting means for detecting a user load electric power, a power generation output deriving means for deriving the power generation output of the fuel cell depending on the user load electric power detected by the user load electric power detecting means, judgment means for judging whether or not the power generation output limit value derived by the first power generation output limit value deriving means is equal to or greater than the power generation output derived by the power generation output deriving means, and restriction control means for restricting the power generation output of the fuel cell to the power generation output limit value when the power generation output limit value is judged by the judgment means to be less than the power generation output.

Further the structural feature of the invention according to Claim 14 resides in that in Claim 12 or 13, there are further provided a first heating medium circulation circuit for circulating first heating medium having collected the waste heat from the fuel cell, a second heating medium circulation circuit for circulating second heating medium having collected the waste heat from the reformer, a first heat exchanger for performing heat exchange between the reserved hot water and the first heating medium, a second heat exchanger for performing heat exchange between the reserved hot water and the second heating medium, and cooler means provided on the second heating medium circulation circuit for cooling the second heating medium, and that the first map or calculation expression is made by deriving power generation outputs of the fuel cell corresponding to cooling capabilities of the cooler means at respective temperatures of the reserved hot water, based on a second map or calculation expression representing the correlation of required cooling capabilities for the fuel cell system with power generation outputs of the fuel cell at respective temperatures of the reserved hot water and based on a cooling capability of the cooler means.

Further, the structural feature of the invention according to Claim 15 resides in that in Claim 14, the cooling capability of the cooler means is a required cooling capability for the fuel cell system corresponding to the minimum power generation output of the fuel cell with the hot water tank filled up with the hot water, based on the correlation, by the second map or calculation expression, of the required cooling capability for the fuel cell system with the power generation output of the fuel cell at the maximum temperature of the reserved hot water.

Further, the structural feature of the invention according to Claim 16 resides in that in any one of Claims 1 to 11, there are provided fuel gas fuel cell inlet temperature detecting means for detecting the temperature of the fuel gas flowing to the inlet of the fuel cell or the temperature of one correlating with the temperature of the fuel gas, second power generation output limit value deriving means for comparing the temperature detected by the fuel gas fuel cell inlet temperature detecting means with a predetermined temperature and for deriving a power generation output limit value for the fuel cell based on the comparison result, and second power generation control means for controlling the power generation output of the fuel cell based on the power generation output limit value derived by the second power generation output limit value deriving means.

Further, the structural feature of the invention according to Claim 17 resides in that in Claim 16, the second power generation output limit value deriving means calculates a present power generation output limit value by subtracting a predetermined amount from a preceding power generation output limit value when the temperature is over the predetermined temperature, but calculates the present power generation output limit value by adding the predetermined amount to the preceding power generation output limit value when the temperature is under the predetermined temperature.

Further. The structural feature of the invention according to Claim 18 resides in that in Claim 16 or 17, the second power generation control means comprises user load electric power detecting means for detecting a user load electric power, power generation output deriving means for deriving the power generation output of the fuel cell in dependence on the user load electric power detected by the user load electric power detecting means, judgment means for judging whether or not the power generation output limit value derived by the second power generation output limit value deriving means is equal to or greater than the power generation output derived by the power generation output deriving means, and restriction control means for controlling the power generation output of the fuel cell to be restricted to the power generation output limit value when the power generation output limit value is judged by the judgment means to be less than the power generation output.

### EFFECT OF THE INVENTION

In the invention according to Claim 1 as constructed above, the heating medium circulation circuit circulates the heating medium which has collected at least either the waste heat of offgas exhausted from the fuel cell or the waste heat generated in the reformer and the waste heat generated through the power generation by the fuel cell, is provided independently of the reserved hot water circulation circuit and performs the heat exchange between the reserved hot water and the heating medium through the heat exchanger. That is, the reserved hot water is not subjected to direct heat exchange with anode offgas, cathode offgas, combustion exhaust gas and fuel gas (reforming gas), but is subjected to indirect heat exchange therewith through the heat exchanger. Thus, where the reserved hot water tank is a sealed type that has tap water replenished directly the tap water pressure at a high pressure would be applied to the reserved hot water tank and the reserved hot water circulation circuit. However, since the heating medium circulation circuit is independent of the reserved hot water circulation circuit, the tap water pressure is not applied directly to the heat exchanger which is arranged on the heating medium circulation circuit for performing the heat exchange with the anode offgas, the cathode offgas, the combustion exhaust gas and the fuel gas (reforming gas). Therefore, since the heat exchanger is not required to take an excess pressure-resistive structure, it can be realized to provide a fuel cell system which is capable of replenishing water for the reserved hot water from a high-pressure water source without inviting increases in cost and dimension.

In the invention according to Claim 2 as constructed above, since in the invention according to Claim 1, at east either one of the reserved hot water circulation circuit and the heating medium circulation circuit is provided with the cooler means for cooling fluid, it becomes possible to efficiently cool the temperature of the reserved hot water or/and the heating medium by the cooler means so that when the temperature of the reserved hot water reaches a required temperature for the fuel cell or a required temperature for the heating medium having collected the waste heat from the reformer, the reserved hot water does not further increase in temperature by collecting the waste heat.

In the invention according to Claim 3 as constructed above, since in the invention according to Claim 1 or 2, the at least either one of the reserved hot water circulation circuit and the heating medium circulation circuit is provided with the bypath passage for bypassing the heat exchanger, at any one of the reserved hot water and the heating medium flows through the heat exchanger, so that the heat exchange can be performed at the heat exchanger adequately in dependence on the temperature of the reserved hot water or the like.

In the invention according to Claim 4 as constructed above, the first heating medium circulation circuit in the invention according to Claim 1 circulates the first heating medium having collected the waste heat which is generated through the power generation by the fuel cell, is provided independently of the reserved hot water circulation circuit and performs heat exchange between the reserved hot water and the first heating medium through the first heat changer. Further, the second heating medium circulation circuit circulates the second heating medium having collected at least either one of the waste heat of offgas exhausted from the fuel cell and the waste heat generated in the reformer, is provided independently of the reserved hot water circulation circuit and performs heat exchange between the reserved hot water and the second heating medium through the second heat exchanger. That is, the reserved hot water is not subjected to direct heat exchange with anode offgas, cathode offgas, combustion exhaust gas and fuel gas (reforming gas), but is subjected to indirect heat exchange through the second heat exchanger. Thus, where the reserved hot water tank is a sealed type that has tap water replenished directly, the tap water pressure at a high pressure would be applied to the reserved hot water tank and the reserved hot water circulation circuit. However, since the second heating medium circulation circuit is independent of the reserved hot water circulation circuit, the tap water pressure is not applied directly to the heat exchanger which is arranged on the second heating medium circulation circuit. Therefore, since the heat exchanger is not required to take an excess pressure-resistive structure it can be realized to provide a fuel cell system which is capable of replenishing water for the reserved hot water from a high-pressure water source without inviting increases in cost and dimension.

In the invention according to Claim 5 as constructed above, since in the invention according to Claim 4, the second heating medium circulation circuit is provided thereon with the condenser for collecting heat from the high temperature, steam-impregnating gas which circulates through the reformer and the fuel cell, and for condensing the steam and since the second heating medium is condensing refrigerant which circulates through the condenser, it becomes possible to raise the temperature of the second heating medium in a simplified construction without increasing the dimension by effectively utilizing the conventional structure.

In the invention according to Claim 6 as constructed above, since in Claim 4, at least any one of the reserved hot water circulation circuit and the first and second heating medium circulation circuits is provided with the cooler means for cooling fluid, it becomes possible to efficiently cool the temperature of the reserved hot water or/and the first and second heating mediums by the cooler means so that when the temperature of the reserved hot water reaches a required temperature for the fuel cell or a required temperature for the heating medium having collected the waste heat from the reformer, the reserved hot water does not further increase in temperature by collecting the waste heat.

In the invention according to Claim 7 as constructed above, since in the invention according to any one of Claims 4 to 6, at least any one of the reserved hot water circulation circuit and the second heating medium circulation circuit is provided with the bypath passage for bypassing the second heat exchanger at least any one of the reserved hot water and the second heating medium flows through the second heat exchanger, so that the heat exchange can be performed by the second heat exchanger adequately in dependence on the temperature of the reserved hot water or the like.

In the invention according to Claim 8 as constructed above, since in the invention according to any one of Claims 4 to 6, at least either one of the reserved hot water circulation circuit and the first heating medium circulation circuit is provided with the bypath passage for bypassing the first heat exchanger, at east any one of the reserved hot water and the first heating medium flows through the first heat exchanger, so that the heat exchange can be performed by the first heat exchanger adequately in dependence on the temperature of the reserved hot water or the like.

In the invention according to Claim 9 as constructed above, since in the invention according to Claim 1, the heating medium circulation circuit is provided independently of the reserved hot water circulation circuit ever where it is one circulation circuit for circulating the medium which collects the waste heat generated through the power generation by the fuel cell and which a so collects at east one of the waste heat of offgas exhausted from the fuel cell and the waste heat generated in the reformer, and performs heat exchange between the reserved hot water and the heating medium through the heat exchanger. That is, the reserved hot water is not subjected to direct heat exchange with anode offgas, cathode offgas, combustion exhaust gas and fuel gas (reforming gas) but is subjected to indirect heat exchange therewith through the heat exchanger. Thus, where the reserved hot water tank is a sealed type that has tap water replenished directly, the tap water pressure at a high pressure would be applied to the reserved hot water tank and the reserved hot water circulation circuit. However, since the heating medium circulation circuit is independent of the reserved hot water circulation circuit the tap water pressure is not applied directly to the heat exchanger which is arranged on the heating medium circulation circuit for performing the heat exchange with the anode offgas, the cathode offgas, the combustion exhaust gas and the fuel gas (reforming gas). Therefore, since the heat exchanger is not required to take an excess pressure-resistive structure it can be realized to provide a fuel cell system which is capable of replenishing water for the reserved hot water from the high-pressure water source without inviting increases in cost and dimension.

In the invention according to Claim 10 as constructed above since in the invention according to Claim 9, at least either one of the reserved hot water circulation circuit and the heating medium circulation circuit is provided with cooler means for cooling fluid, it becomes possible to efficiently cool the temperature of the reserved hot water or/and the heating medium by the cooler means so that when the temperature of the reserved hot water reaches a required temperature for the fuel cell or a required temperature for the heating medium having collected the waste heat from the reformer, the reserved hot water does not further increase in temperature by collecting the waste heat.

In the invention according to Claim 11 as constructed above since in the invention according to Claim 9 or 10, at east either one of the reserved hot water circulation circuit and the heating medium circulation circuit is provided with the bypath passage for bypassing the heat exchanger, at least any one of the reserved hot water and the heating medium flows through the heat exchanger, so that the heat exchange can be performed by the heat exchanger adequately in dependence on the temperature of the reserved hot water or the like.

In the invention according to Claim 12 as constructed above the first power generation output limit value deriving means derives a power generation output limit value based on the reserved hot water tank outlet temperature detected by the reserved hot water tank outlet temperature detecting means and the first map or calculation expression representing the correlation between the reserved hot water tank outlet temperature and the power generation output limit value for the fuel cell, and the first power generation control means controls the power generation output of the fuel cell in dependence on the power generation output limit value derived by the first power generation output limit value deriving means. Thus, during the power generation by the fuel cell, the reserved hot water is heated by collecting the waste heats which are generated from the fuel cell and the reformer with the power generation. However, since when the reserved hot water is filled up in the sense of temperature, the power generation output of the fuel cell is restricted in dependence on the reserved hot water tank outlet temperature, the heat generation from the fuel cell can be suppressed as far as possible and the balance is kept between the power generation output and the utilization of the waste heat, so that the operation of the fuel cell system can be performed efficiently while obviating the heat surplus state as far as possible.

In the invention according to Claim 13 as constructed above in the first power generation control means the power generation output deriving means derives the power generation output of the fuel cell depending on the user load electric power detected by the user load electric power detecting means. The judgment means judges whether or not the power generation output limit value derived by the first power generation output limit value deriving means is equal to or greater than the power generation output derived by the power generation output deriving means, and the restriction control means restricts the power generation output of the fuel cell to the power generation output limit value when the power generation output limit value is judged by the judgment means to be less than the power generation output. Thus, the stable operation of the fuel cell system can be realized simply and reliably based on the power generation output of the fuel cell depending on the user load electric power detected by the user load electric power detecting means and the power generation output limit value.

In the invention according to Claim 14 as constructed above, the first map or calculation expression is made by deriving the power generation outputs of the fuel cell corresponding to the cooling capabilities of the cooler means at respective temperatures of the reserved hot water, based on the second map or calculation expression representing the correlation of the required cooling capabilities for the fuel cell system with the power generation outputs of the fuel cell at respective temperatures of the reserved hot water and based on the cooling capability of the cooler means provided on the second heating medium circulation circuit, which circulates the second heating medium having collected the waste heat from the reformer, for cooling the second heating medium. Thus. Since the power generation output limit value is derived based on the reserved hot water tank outlet temperature and the cooling capability of the cooler means, the power generation output of the fuel cell is determined taking the cooling capability of the cooler means into account, and the balance between the power generation output and the utilization of the waste heat is kept in a better state, so that the operation of the fuel cell system can be performed efficiently while obviating the heat surplus state as far as possible.

In the invention according to Claim 15 as constructed above, since the cooling capability of the cooler means is the required cooling capability for the fuel cell system corresponding to the minimum power generation output of the fuel cell with the reserved hot water tank filled up with the hot water, based on the correlation, by the second map or calculation expression, of the required cooling capability for the fuel cell system with the power generation output of the fuel cell at the maximum temperature of the reserved hot water, it is possible to use the cooler means whose cooling capability can be suppressed to a smaller one, and thus, it can be accomplished to make the cooler means compact and hence, the whole fuel cell system compact.

In the invention according to Claim 16 as constructed above, the second power generation output limit value deriving means compares the fuel gas fuel cell inlet temperature detected by the fuel gas fuel cell inlet temperature detecting means or the temperature of one correlating to the temperature of the fuel gas with the predetermined temperature and derives the power generation output limit value for the fuel cell based on the comparison result, and the second power generation control means controls the power generation output of the fuel cell based on the power generation output limit value derived by the second power generation output limit value deriving means. Thus, during the power generation by the fuel cell, the reserved hot water is heated by collecting the waste heats which are generated from the fuel cell and the reformer with the generation. However, since when the reserved hot water tank is filled up in the sense of temperature, the power generation output of the fuel cell is restricted in dependence on the fuel gas fuel cell inlet temperature or the temperature of one correlating to the fuel gas temperature, the heat generation from the fuel cell can be suppressed as far as possible, and the balance is kept between the power generation output and the utilization of the waste heat, so that the operation of the fuel cell system can be performed efficiently while obviating the heat surplus state as far as possible.

In the invention according to Claim 17 as constructed above, the second power generation output limit value deriving means calculates the present power generation output limit value by subtracting the predetermined amount from the preceding power generation output limit value when the temperature detected by the fuel gas fuel cell inlet temperature detecting means is over the predetermined temperature, but calculates the present power generation output limit value by adding the predetermined amount to the preceding power generation output limit value when the temperature is under the predetermined temperature. Thus, it is possible to calculate the power generation output limit value easily and reliably based on the fuel gas fuel cell inlet temperature or the temperature of one correlating to the fuel gas temperature.

In the invention according to Claim 18 as constructed above, in the second power generation control means, the power generation output deriving means derives the power generation output of the fuel cell in dependence on the user load electric power detected by the user load electric power detecting means, the judgment means judges whether or not the power generation output limit value derived by the second power generation power limit value deriving means is equal to or greater than the power generation output derived by the power generation output deriving means, and the restriction control means controls the power generation output of the fuel cell to be restricted to the power generation output limit value when the power generation output limit value is judged by the judgment means to be less than the power generation output. Thus, the stable operation of the fuel cell system can be performed simply and reliably based on the power generation output of the fuel cell corresponding to the user load electric power detected by the user load electric power detecting means and the power generation output limit value.

### BRIEF DESCRIPTION OF THE DRAWINGS

FIG. 1 is a schematic view showing a fuel cell system in a first embodiment according to the present invention.

FIG. 2 is a block diagram showing the fuel cell system shown in FIG. 1.

FIG. 3 is a first map representing the correlation between reserved hot water outlet temperature and FC power generation output limit value.

FIG. 4 is a second map representing the correlation of required cooling capabilities for the fuel cell system with power generation outputs of a fuel cell at respective temperatures of reserved hot water.

FIG. 5 is a flow chart of a control program in a first control example executed by a control device shown in FIG. 2.

FIG. 6 is a time chart showing the operation in the first control example of the fuel cell system according to the present invention.

FIG. 7 is a flow chart of a control program in a second control example executed by the control device shown in FIG. 2.

FIG. 8 is a flow chart of a subroutine of the control program in the second control example executed by the control device shown in FIG. 2.

FIG. 9 is a time chart showing the operation in the second control example of the fuel cell system according to the present invention.

### DESCRIPTION OF REFERENCE SYMBOL

10 . . . fuel cell,
11 . . . fuel pole,
12 . . . air pole,
20 . . . reformer,
21 . . . burner,
22 . . . reforming section,
23 . . . carbon monoxide shift reaction section (CO shift section),
24 . . . carbon monoxide selective oxidization section (CO selective oxidization section),
25 . . . evaporator,
30 . . . condenser,
31 . . . reforming gas condenser,
32 . . . anode offgas condenser,
33 . . . cathode offgas condenser,
34 . . . combustion gas condenser,
40 . . . pure water container,
45 . . . inverter,
46 . . . power line,
47 . . . electric power consumption site,
47a . . . wattmeter,
50 . . . reserved water container,
53 . . . reforming water pump,
61 . . . supply pipe,
62 . . . exhaust pipe,
64-66 . . . pipes,
68 . . . reforming water supply pipe,
71 . . . reserved hot water tank,
72 . . . reserved hot water circulation circuit,
73 . . . FC cooling water circulation circuit,
74 . . . first heat exchanger,
75 . . . condensing refrigerant circulation circuit,
76 . . . second heat exchanger,
77 . . . radiator,
81, 84 . . . bypath passages,
82, 83, 85, 86 . . . first through fourth valves,
P1 to P7, 53 . . . pumps,
73a, 73b, 75a, 72a, 72b, 72c, 64a . . . first through seventh temperature sensors,
47a . . . wattmeter,
90 . . . control device,
91 . . . storage device.

### PREFERRED EMBODIMENTS FOR PRACTICING THE INVENTION

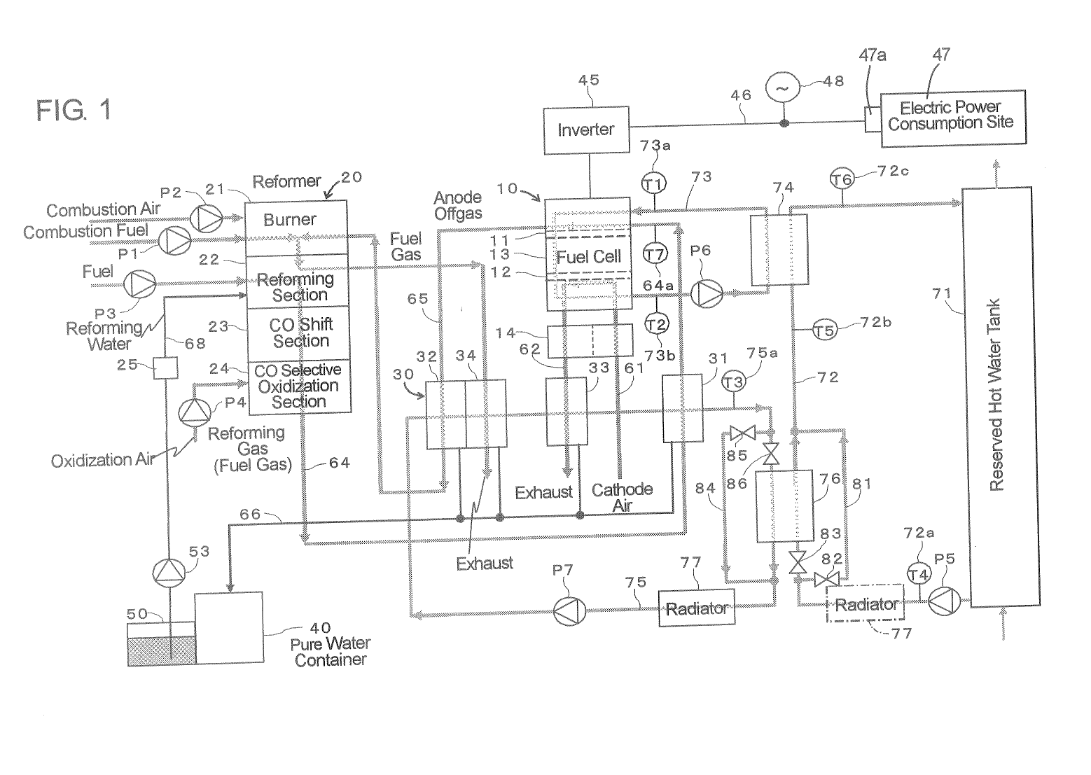

Hereafter, description will be made regarding a fuel cell system in a first embodiment according to the present invention. FIG. 1 is a schematic view showing the outline of the fuel cell system. The fuel cell system is provided with a fuel cell 10 and a reformer 20 for generating reforming gas (fuel gas) including hydrogen gas necessary for the fuel cell 10.

The fuel cell 10 is provided with a fuel pole 11, an air pole 12 being an oxidizer pole and an electrolyte 13 interposed between the both poles 11, 12 and generates an electric power by the use of the reforming gas supplied to the fuel pole 11 and air (cathode air) being the oxidizer gas supplied to the air pole 12. The air pole 12 of the fuel cell 10 has connected thereto a supply pipe 61 for supplying air and an exhaust pipe 62 for exhausting cathode offgas, and a humidifier 14 for humidifying air is provided over the supply pipe 61 and the exhaust pipe 62. The humidifier 14 is of a steam replacement type that dehumidifies steam in the gas exhausted to the exhaust pipe 62, that is, from the air pole 12 and that supplies the steam to the air supplied into the supply pipe 61, that is, to the air pole 12 to humidify the air. Instead of air, there may be supplied gas which is enriched with oxygen in the atmosphere.

The reformer 20 is for steam-reforming the fuel and for supplying the fuel cell 10 with the reformed gas which is rich in hydrogen and is composed of a burner 21, a reforming section 22, a carbon monoxide shift reaction section (hereafter referred to as CO shift section) 23 and a carbon monoxide selective oxidization section (CO selective oxidization section) 24. As the fuel, there may be employed natural gas, LPG, kerosene, gasoline, methanol or the like, and description in the present embodiment will be made regarding natural gas.

The burner 21 is supplied with combustion fuel and combustion air from outside at the time of operation start, and is supplied with anode offgas (reforming gas supplied to the fuel cell but exhausted without being consumed) from the fuel pole 11 of the fuel cell 10 at the time of ordinary operation, wherein the burner 21 combusts each supplied gas and leads the combusted gas to the reforming section 22. The combusted gas heats the reforming section 22 (to an active temperature range of a catalyzer for the reforming section 22) and then goes through a combustion gas condenser 34 to condense the steam included therein before being exhausted outside. Further the combustion fuel and the combustion air are supplied to the burner 21 by a combustion fuel pump P1 and a combustion air, pump P2 which are combustion fuel supply means and combustion air supply means, respectively. The both pumps P1, P2 are controllable by a control device 90 to have their flow quantities (outflow volumes) put under control.

The reform section 22 reforms a mixture gas, made by mixing the steam (reforming water) from an evaporator 25 with the fuel supplied from the outside, by the catalyzer fined in the reforming section 22 and generates hydrogen gas and carbon monoxide gas (a so-called steam reforming reaction). At the same time, it regenerates hydrogen gas and carbon dioxide from the carbon monoxide and steam which are generated in the steam reforming reaction (a so-called carbon monoxide shift reaction). The generated gas (i.e., reforming gas) is led to the CO shift section 23. The fuel is supplied to the reforming section 22 by a fuel pump P3 being fuel supply means. This pump P3 is controllable by the control device 90 to have its flew quantity (outflow volume put under control.

The CO shift section 23 reacts the carbon monoxide and steam included in the reforming gas by the catalyzer filled therein to regenerate hydrogen gas and carbon dioxide gas. Thus, the reforming gas with the carbon monoxide reduced in density is led to the CO selective oxidization section 24.

The CO selective oxidization section 24 regenerates carbon dioxide by reacting the carbon oxide remaining in the reforming gas with air for CO oxidization which air is further supplied from the outside, by a catalyzer filled therein. Thus, the reforming gas is further reduced (less than 10 ppm) in the density of carbon monoxide and is led to the fuel pole 11 of the fuel cell 10. Further, the air for CO oxidization is supplied to the CO selective oxidization section 24 by a CO oxidization air pump P4 being CO oxidization air supply means. This pump P4 is controllable by the control device 90 to have its flow quantity (outflow volume) put under control.

The evaporator 25 is arranged on a reforming water supply pipe 68 which has its one end located in the reserved water container 50 and its other end connected to the reforming section 22. A reforming water pump 53 is provided on the reforming water supply pipe 68. The pump 53 is under the control of the control device 90 and feeds with a pressure a collected water which is in the reserved water container 50 for use as reforming water. The evaporator 25 is heated by, e.g., the combusted gas exhausted from the burner 21 the heats from the reforming section 22 and the CO shift section 23 or the like and thus evaporates the pressure-fed reforming water.

A condenser 30 is provided on a pipe 64 which makes the CO selective oxidization section 24 of the reformer 20 communicate with the fuel pole 11 of the fuel cell 10. The condenser 30 (though divided in the figure) is a single body structure which bodily joints a reforming gas condenser 31, an anode offgas condenser 32, a cathode offgas condenser 33 and the combustion gas condenser 34. The reforming gas condenser 31 condenses the steam in the reforming gas which flows through the pipe 64 to be supplied to the fuel pole 11 of the fuel cell 10. The anode offgas condenser 32 is provided on a pipe 65 which makes the fuel pole 11 of the fuel cell 10 communicate with the burner 21 of the reformer 20, and condenses the steam in the anode offgas which is exhausted from the fuel pole 11 of the fuel cell 10 to flow through the pipe 65. The cathode offgas condenser 33 is provided downstream of the humidifier 14 on the exhaust pipe 62 and condenses the steam in the cathode offgas which is exhausted from the air pole 12 of the fuel cell 10 to flow through the exhaust pipe 62. The combustion gas condenser 34 is provided downstream of the burner 21 and collects the latent heat having condensed the steam, together with the sensible heat of the combusted exhaust gas.

The aforementioned condensers 31-34 are in communication with a pure water container 40 through a pipe 66, whereby the condensed waters condensed by the respective condensers 31-34 are led and collected into the pure water container 40. The pure water container 40 makes pure water from the condensed water or collected water, supplied from the condenser 30, through ion exchange resin built therein and leads the collected water so purified to the reserved water container 50. The reserved water container 50 is for temporality storing as reforming water the collected water led from the pure water container 40. The pure water container 40 has connected thereto a pipe for leading replenished water (tap water) supplied from a tap water supply source (e.g., water pipe), so that the pure water container 40 is supplied with tap water when the quantity of the reserved water therein falls down a lower limit level.

The fuel cell system is provided with a reserved hot water tank 71 for storing reserved hot water, a reserved hot water circulation circuit 72 for circulating the reserved hot water an FC cooling water circulation circuit 73 which is a first heating medium circulation circuit for circulating FC cooling water as first heating medium having collected the waste heat generated through the power generation by the fuel cell 10, a first heat exchanger 74 for performing heat exchange between the reserved hot water and the FC cooling water, a condensing refrigerant circulation circuit 75 which is a second heating medium circulation circuit for circulating condensing refrigerant (condenser heating medium) as second heating medium having collected at least either of the waste heat of the offgas exhausted from the fuel cell 10 and the waste gas generated in the reformer 20, and a second heat exchanger 76 for performing heat exchange between the reserved hot water and the condensing refrigerant. Thus, the waste heat (thermal energy) generated in the fuel cell 10 is collected by the FC cooling water and is then collected by the reserved hot water through the first heat exchanger 74, whereby the reserved hot water is heated (raised in temperature). Further, the waste heat (thermal energy) generated in the reformer 20 is collected by the condensing refrigerant through the condenser 30 and is then collected by the reserved hot water through the second heat exchanger 76, whereby the reserved hot water is heated (raised in temperature). “FC” in the present description and the accompanying drawings is noted as the abbreviation for “fuel cell”.

The reserved hot water tank 71 is provided with a one pillar-like container, in which hot water is stored in a layered structure, that is, in such a form that the er is the highest on the top portion, becomes lower as the layer goes down and is the lowest at the bottom portion. Water (low temperature water) such as tap water is replenished to the bottom of the pillar-like container of the reserved hot water tank 71, while the high temperature hot water stored in the reserved hot water tank 71 is led out from the top of the pillar-like container of the reserved hot water tank 71. The reserved hot water tank 71 is of a sealed type, so that it is of the type that the tap water pressure acts inside and hence, on the reserved hot water circulation circuit 72 as it is.

One end and the other end of the reserved hot water circulation circuit 72 are connected to the bottom and top of the reserved hot water tank 71. From the one end toward the other end thereof, the reserved hot water circulation circuit 72 has arranged thereon in order a reserved hot water circulating pump P5 being reserved hot water circulating means, a fourth temperature sensor 72a, the second heat exchanger 76, a fifth temperature sensor 72b, the first heat exchanger 74 and a sixth temperature sensor 72c. The reserved hot water circulating pump P5 is for drawing the reserved hot water at the bottom of the reserved hot water tank 71 to discharge the reserved hot water toward the top of the reserved hot water tank 71 by way of the reserved hot water circulation circuit 72 and is controllable by the control device 90 to have its flow quantity (outflow volume) put under control. The fourth to sixth temperature sensors 72a-72c respectively detect the temperature of the reserved hot water at an outlet of the reserved hot water tank 71, the temperature of the reserved hot water at an inlet of the first heat exchanger 74, and the temperature of the reserved hot water at an outlet of the first heat exchanger 74 and output these detection results to the control device 90.

The reserved hot water circulation circuit 72 is provided with a bypath passage 81 which bypasses the second heat exchanger 76. The bypath passage 81 has provided thereon a first valve 82 for controlling the opening/closing of the bypath passage 81 in response to a command from the control device 90. A second valve 83 for controlling the opening/closing of the reserved hot water circulation circuit 72 in response to a command from the control device 90 is provided on a part of the reserved hot water circulation circuit 72 which part is between a branch start point of the bypath passage 81 and the second heat exchanger 76. The reserved hot water flows through the second heat exchanger 76 when the first and second valves 82, 83 are respectively brought into closed and open states, but flows through the bypath passage 81 without flowing through the second heat exchanger 76 when the first and second valves 82, 83 are respectively brought into open and closed states. Thus, the flow path for the reserved hot water is selectable from the second heat exchanger 76 and the bypath passage 81.

The FC cooling water circulation circuit 73 has arranged thereon an FC cooling water circulating pump P6 being FC cooling water circulating means, and the FC cooling water circulating pump P6 is controllable by the control device 90 to have its flow quantity (outflow volume) put under control. Further, the FC cooling water circulation circuit 73 has arranged thereon first and second temperature sensors 73a, 73b, which respectively detect the temperatures of FC cooling water at the inlet and outlet of the fuel cell 10 to output the detection results to the control device 90. Further, the first heat exchange 74 is arranged on the FC cooling water circulation circuit 73.

The condensing refrigerant circulating pump P7 being condensing refrigerant circulating means is arranged on the condensing refrigerant circulation circuit 75 and is controllable by the control device 90 to have its flow quantity (outflow volume) put under control. Further, in order from the upstream side, the condensing refrigerant circulation circuit 75 has arranged thereon the anode offgas condenser 32, the combustion gas condenser 34, the cathode offgas condenser 33 and the reforming gas condenser 31. Further, the condensing refrigerant circulation circuit 75 has arranged thereon a third temperature sensor 75a, which detects the temperature of the condensing refrigerant at the outlet of the reforming gas condenser 31 to output the detection result to the control device 90. Additionally, the second heat exchanger 76 is arranged on the condensing refrigerant circulation circuit 75. The order in arrangement of the respective condensers 31-34 is not limited to that order as aforementioned, and the respective condensers 31-34 are not limited to being serially arranged on a single pipe. The condensing refrigerant circulation circuit 75 may be branched into a plurality of branched passages, on which the respective condensers 31-34 may be arranged respectively in a parallel fashion. Further, at least the reforming gas condenser 31 is arranged on the condensing refrigerant circulation circuit 75.

Further, a radiator 77 which is cooler means for cooling the condensing refrigerant is arranged on the condensing refrigerant circulation circuit 75 immediate downstream of the second heat exchanger 76. The radiator 77 is controllable to be turned ON/OFF in response to a command from the control device 90 and cools the condensing refrigerant in ON state, but does not in OFF state. The cooling capability of the radiator 77 is a required cooling capability H1 for the fuel cell system which capability is specified by the minimum power generation output E1, of the fuel cell 10 with the reserved hot water tank 71 filled up with hot water, on a graph or calculation expression which represents the correlation of the required cooling capability for the fuel cell system with the power generation output of the fuel cell 10 at the maximum temperature Tₘₐₓ of the reserved hot water, as shown in a second map referred to later. Because the maximum temperature Tₘₐₓ of the reserved hot water is regulated by the maximum temperature (e.g., 60-70 centigrade) to which the fuel cell 10 is heated, it does not occur that the temperature of the reserved hot water rises over that temperature. The radiator 77 may be arranged on the reserved hot water circulation circuit 72 or the FC cooling water circulation circuit 73 and suffices to be arranged on at least any one of the condensing refrigerant circulation circuit 75, the reserved hot water circulation circuit 72 and the FC cooling water circulation circuit 73. With this arrangement, when the temperature of the reserved hot water reaches a temperature required for the fuel cell or a temperature required for the condensing refrigerant having collected the waste heat from the reformer 20, the temperature of the reserved hot water or/and the first and second heating mediums can be efficiently cooled by the radiator 77 being the cooler means in order that the reserved hot water does not further increase in temperature by collecting the waste heat.

Further, the condensing refrigerant circulation circuit 75 is provided with a bypath passage 84 which bypasses the second heat exchanger 76. The bypath passage 84 is provided thereon with a third valve 85 for controlling the opening/closing of the bypath passage 84 in response to a command from the control device 90. A fourth valve 86 for controlling the opening/closing of the condensing refrigerant circulation circuit 75 in response to a command from the control device 90 is provided on a part of the condensing refrigerant circulation circuit 75 which part is between a branch start point of the bypath passage 84 and the second heat exchanger 76. The condensing refrigerant flows through the second heat exchanger 76 when the third and fourth valves 85, 86 are respectively brought into closed and open states but flows through the bypath passage 84 without flowing through the second heat exchanger 76 when the third and fourth valves 85, 86 are respectively brought into open and closed states. Thus, the flow path for the condensing refrigerant is selectable from the second heat exchanger 76 and the bypath passage 84, and together with the aforementioned flow path selection for the hot water, it becomes possible to realized a case that the hot water both flow through the second heat exchanger 76, another case that they flow respectively through the bypath passages 84, 81 and another case that the condensing refrigerant and the hot water flow respectively through the second heat exchanger 76 and the bypath passage 84 (or 81). Either one of the bypath passages 81, 84 may be provided.

Further, the fuel cell system is provided with an inverter 45 (electric power converter) 45. The inverter 45 is for converting the power generation output of the fuel cell 10 into the alternate current power and for supplying the same through a power transmission cable 46 to an electric power consumption site 47 on a user side. At the electric power consumption site 47, there are installed load devices (not shown) which are electric appliances such as light, electric iron, TV, washer, electric kotatsu, electric carpet, air conditioner, refrigerator and the like, so that the alternate current power supplied from the inverter 45 is supplied to the load devices when necessary. The power transmission cable 46 which connects the inverter 45 to the electric power consumption site 47 has also connected thereto a system power supply 48 of an electric power company (system linkage), and when the total consumed electric power by the load devices exceeds the power generation output of the fuel cell 10, the compensation can be made by receiving the deficiency electric power from the system power supply 48. A watt meter 47a is user load electric power detecting means for detecting the user load electric power (user-consumed electric power) and detects the total consumed power by al the load devices used in the electric power consumption site 47, to transmit the detected electric power to the control device 90.

Further, the inverter 45 drops or boosts the voltage of the power generation output and supplies the direct-current power to electric components, so-called auxiliary devices including the respective pumps P1-P7, 53, the respective valves (not shown), an ignition device for the burner 21, and the like which are the components of the fuel cell system. Further, the inverter 45 is arranged on the condensing refrigerant circulation circuit 75, so that the inverter 45 can be cooled by the condensing refrigerant.

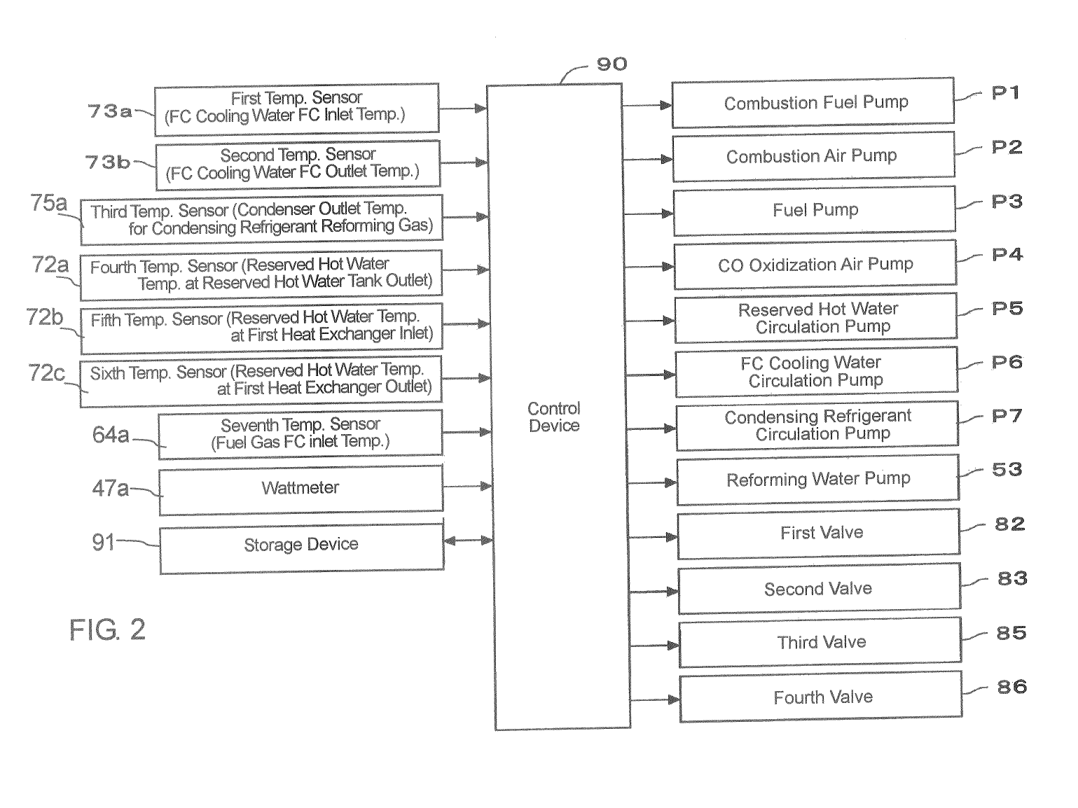

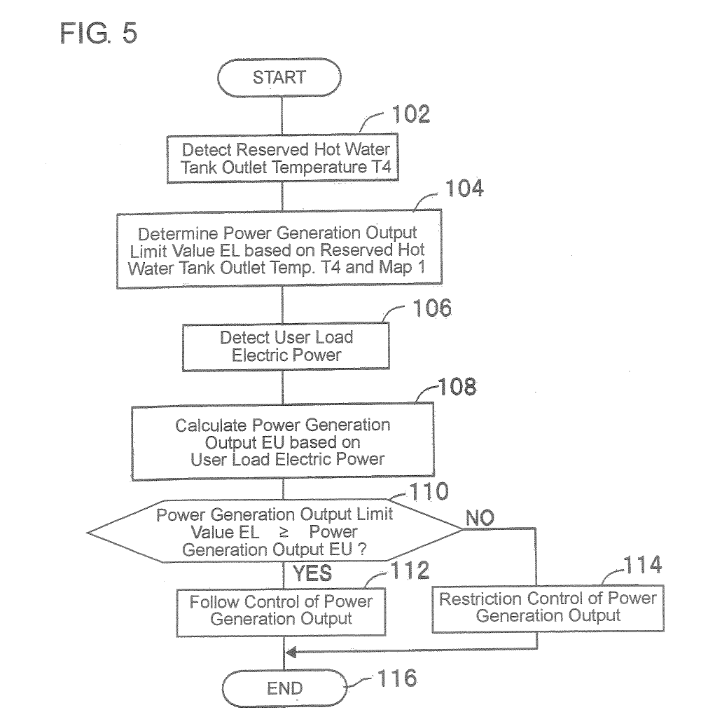

Further, the control device 90 has connected thereto the aforementioned respective temperature sensors 73a, 73b, 75a, 72b, 72c, 64a, the respective pumps P1-P7, 53 and the wattmeter 47a (refer to FIG. 2). The control device 90 has a microcomputer (not shown), and the microcomputer is provided with an input/output interface a CPU, a RAM and a ROM (al not shown) which are connected to one another through a bus. The CPU controls the power generation output of the fuel cell 10 based on any of the temperatures detected by the respective temperature sensors 73a, 73b, 75a, 72a, 72b, 72c, 64a and the user load electric power detected by the wattmeter 47a, by executing programs corresponding to flow charts shown in FIG. 5 or 7 and FIG. 8. The RAM temporally stores variables needed in executing the programs, and the ROM stores the programs.

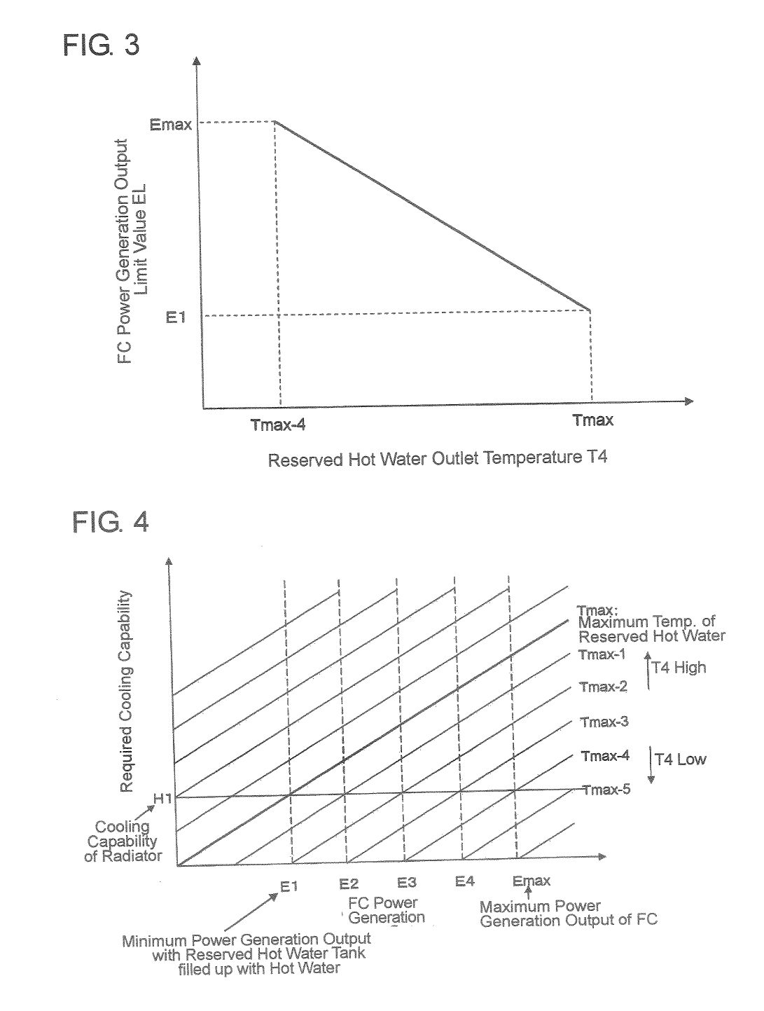

Further, a storage device 91 is connected to the control device 90 and stores a first map or calculation expression shown in FIG. 3. The first map or the calculation expression represents the correlation between the reserved hot water tank outlet temperature T4 detected by the fourth temperature sensor 72a being the reserved hot water tank outlet temperature detecting means and a power generation output limit value EL for the fuel cell 10. As apparent from the first map or calculation expression the reserved hot water tank outlet temperature T4 is in inverse proportional relation to the power generation output value EL for the fuel cell 10.

The first map or calculation expression can be made by deriving the power generation outputs of the fuel cell 10 corresponding to the cooling capabilities of the radiator 77 at respective temperatures of the reserved hot water, based on a second map or calculation expression which represents the correlation of required cooling capabilities for the fuel cell system with the power generation outputs of the fuel cell 10 at respective temperatures of the reserved hot water, and based on the cooling capability of the radiator 77. First of al, the second map or calculation expression is made as follows. As shown in FIG. 4, a required cooling capability for the fuel cell system relative to the FC power generation output is obtained by calculation or measurement in the state that the reserved hot water circulating through the reserved hot water circulation circuit 72 is held constant in temperature. With the temperature varied then within a predetermined range, that is, at respective temperature Tₘₐₓ₋₁-Tₘₐₓ₋₄ which have beer in turn decreased by the unit of a predetermined temperature from, e.g., the maximum temperature Tₘₐₓ of the reserved hot water tank 71, graphs functions) specifying the required cooling capabilities for the fuel cell system relative to the FC power generation outputs are obtained by calculation or measurement. In this way, it becomes possible to make the second map or calculation expression. On the other hand, as mentioned earlier, the cooling capability of the radiator 77 is specified as the required cooling capability H1 for the fuel cell system which capability corresponds to the minimum power generation output E1 of the fuel cell 10 in the state of the reserved hot water tank 71 having been filled up with hot water, by the graph or calculation expression which represents the correlation of the required cooling capability for the fuel cell system with the power generation output of the maximum temperature Tₘₐₓ of the reserved hot water.

Accordingly, the power generation output of the fuel cell 10 corresponding to the cooling capability E1 of the radiator 77 which output is on the graph or calculation expression representing the correlation of the required cooling capabilities for the fuel cell system with the previously calculated power generation outputs of the fuel cell 10 at respective temperatures of the reserved hot water is derived as FC power generation output limit value EL. Specifically, where the temperature of the reserved hot water (i.e., the temperature T4 at the outlet of the reserved hot water tank) is Tₘₐₓ, the FC power generation output limit value EL is E1 as aforementioned, where it is Tₘₐₓ₋₁, the FC power generation output limit value EL is E2; where it is Tₘₐₓ₋₂, the FC power generation output limit value EL is E3; where it is Tₘₐₓ₋₃, the FC power generation output limit value EL is E4- and where it is Tₘₐₓ₋₄ the FC power generation output limit value EL is Eₘₐₓ. The predetermined temperature range is the range that runs from the maximum temperature Tₘₐₓ of the reserved hot water tank to the temperature that the FC power generation output limit value EL becomes the maximum power generation output Eₘₐₓ of the fuel cell 10 (Tₘₐₓ₋₄ in his embodiment).

Since the capability of the radiator 77 changes in dependence on the outside air (radiator refrigerant temperature), the efficiency can further be enhanced by having/calculating the maps shown in FIGS. 3 and 4 for each of the respective outside temperatures. The condition that is the hardest in the outside temperature during a summer season is selected in determining the capability of the radiator 77.

Next, description will be made regarding the control for optimization of heat collection efficiency in the aforementioned fuel cell system. First of all, the reserved hot water circulating pump P5 is controlled in flow volume so that the FC inlet temperature T1 of the FC cooling water becomes the optimum operation temperature for the fuel cell. Further, the FC cooling water circulating pump P6 is controlled in flow volume so that the temperature difference ΔT between the FC cooling water FC inlet temperature T1 and the FC cooling water FC outlet temperature T2 becomes a target temperature difference ΔT* (e.g., 3-5 centigrade). The target temperature difference ΔT* has been set to maintain the steam in the reforming gas flow passage or the air flow passage for the fuel cell 10 in an optimum humidity condition. Then, the condensing refrigerant circulating pump P7 is controlled in flow volume so that the condensing refrigerant temperature T3 at the anode offgas (AOG) condenser outlet becomes a target temperature T3*(e.g., 50-60 centigrade). The higher the condensing refrigerant temperature T3 at the reforming gas condenser outlet, the better the efficiency in collecting the condenser-collected heat quantity of the reserved hot water in the second heat exchanger 76 becomes. Thus, it is desirable to set the target temperature T3* to be high. On the other hand, when the condensing refrigerant temperature T3 at the reforming gas condenser outlet becomes high, the temperature of the reforming gas which is subjected to heat exchange with the condensing refrigerant by the reforming gas condenser 31, that is, the reforming gas temperature T7 at the FC inlet rises whereby flooding would occur at the fuel pole 11 of the fuel cell 10. Therefore, the target temperature T3* has been set to a temperature which makes the collection efficiency of the condenser collected heat quantity as high as possible within a range that the flooding does not occur.

### 1a) First Control Example

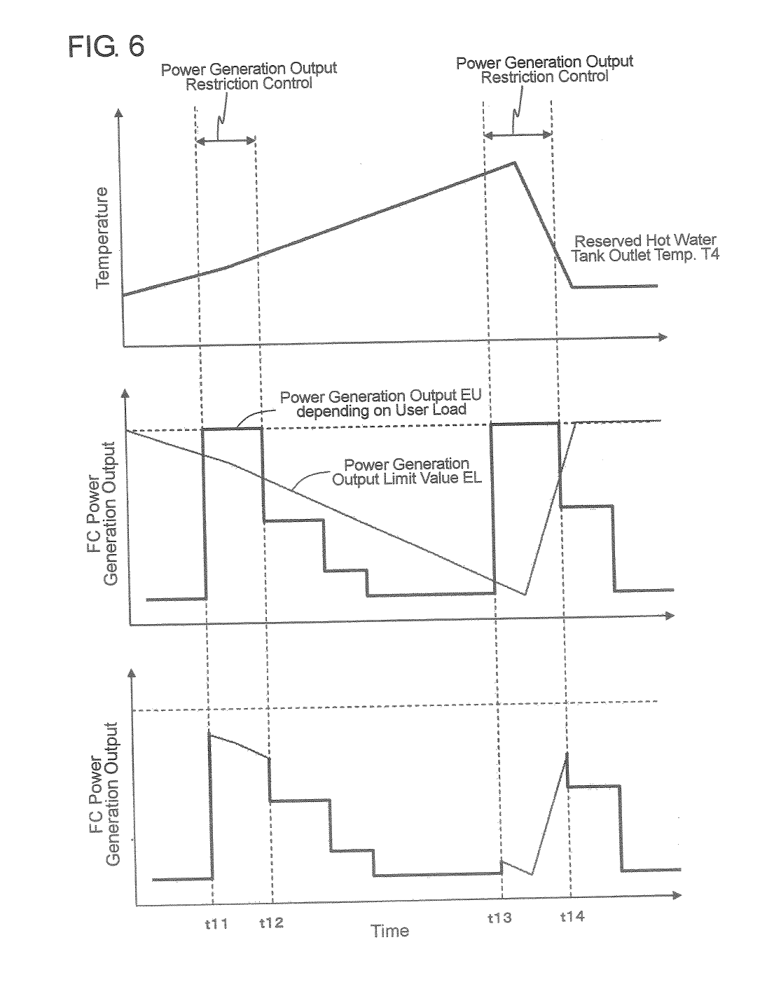

Hereafter, a first control example for the aforementioned fuel cell system will be described with reference to FIGS. 5 and 6. After turning a start switch (not shown) ON brings the fuel cell system into operation there comes an ordinary operation capable of generating electric power upon completion of the start operation and the control device 90 executes the program shown in FIG. 5 at predetermined short time intervals. The control device 90 at step 102 detects the reserved hot water temperature T4 at the reserved hot water tank outlet (reserved hot water tank outlet temperature) by the fourth temperature sensor 72a. Then, at step 104, the control device 90 derives a power generation output limit value EL based on the reserved hot water tank outlet temperature T4 detected at step 102 and the first map or calculation expression representing the correlation between the reserved hot water tank outlet temperature T4 and the power generation output limit value EL for the fuel cell 10 (first power generation output limit value deriving means).

At steps 106-114, the control device 90 controls the power generation output of the fuel cell 10 based on the power generation output limit value EL derived by the first power generation output limit value deriving means (first power generation control means). Specifically, at step 106, the control device 90 detects a user load electric power by the wattmeter 47a (user load electric power detecting means). At step 108, the control device 90 derives the power generation output EU of the fuel cell depending on the user load electric power detected at step 106, based on another map or calculation expression representing the correlation between the user load electric power and the power generation output (power generation output deriving means). At step 110, the control device 90 judges whether or not the power generation output limit value EL derived at step 104 is equal to or greater than the power generation output EU derived at step 108 judgment means). At step 112, the control device 90 controls the power generation output of the fuel cell 10 to follow the user load electric power when the power generation output limit value EL is judged to be greater than the power generation output EU (follow control means). Further, at step 114, the control device 90 controls the power generation output of the fuel cell 10 to be restricted to the power generation output limit value EL when the power generation output limit value EL is judged to be less than the power generation output EU (restriction control means). In any control of the aforementioned follow control and the restriction control, the fuel supply quantity, the reforming water supply quantity, the combustion fuel supply quantity, the combustion air supply quantity and the CO oxidization air supply quantity are derived so that the power generation output of the fuel cell 10 becomes that taking the combustion efficiency into consideration, and the flow quantities from the fuel pump P3, the reforming water pump 53, the combustion fuel pump P1, the combustion air pump P2 and the CO oxidization pump P4 are controlled by the control device 90 so that the supply quantities respectively become those derived.

In accordance with this control, when the reserved hot water tank outlet temperature T4 varies as indicated at the top row in FIG. 6, the power generation output limit value EL varies reversely of the reserved hot water tank outlet temperature T4 by the processing at step 104, as shown at the middle row in FIG. 6. On the other hand, when the power generation output EU depending on the user load varies as indicated at the middle row in FIG. 6, the power generation output is restricted to the power generation output limit value EL because the power generation output limit value EL is less than the power generation output EU during time period t11-t12 and during time period t13-t14. During other time periods, the power generation output limit value EL is equal to or greater than the power generation output EU, and thus, the follow control is performed wherein the power generation output follows the user load electric power without being restricted (the bottom row in FIG. 6).

Therefore, according to the present first control example, the first power generation output limit value deriving means derives the power generation output limit value EL based on the reserved hot water tank outlet temperature T4 detected by the fourth temperature sensor 72a and the first map or calculation expression representing the correlation between the reserved hot water tank outlet temperature T4 and the power generation output limit value EL for the fuel cell 10, and the first power generation control means controls the power generation output of the fuel cell 10 based on the power generation output limit value EL derived by the first power generation output limit value deriving means. Thus, during the power generation by the fuel cell 10, the reserved hot water is heated by collecting the waste heats which are generated from the fuel cell 10 and the reformer 20 with such power generation. However, when the reserved hot water tank 71 becomes filed in the sense of temperature, the power generation output of the fuel cell 10 is restricted in dependence on the reserved hot water tank outlet temperature T4. Therefore, the heat generation from the fuel cell 10 can be restricted as far as possible, and the balance is kept between the power generation output and the utilization of the waste heat, so that the operation of the fuel cell system can be performed efficiently while obviating the heat surplus state as far as possible.

Further, in the first power generation control means, step 108 derives the power generation output EU for the fuel cell depending on the user load electric power detected at step 106, step 110 judges whether or not the power generation output limit value EL derived at step 104 is equal to or greater than the power generation output EU derived at step 108, step 112 controls the power generation output of the fuel cell 10 to follow the user lad electric power when the power generation output limit value EL is judged at step 110 to be equal to or greater than the power generation output EU, and step 114 controls the power generation output of the fuel cell 10 to be restricted to the power generation output limit value when the power generation output limit value EL is judged at step 110 to be less than the power generation output EU. Thus, it can be realized to perform the stable operation of the fuel cell system simply and reliably based on the power generation output EU of the fuel cell depending on the user load electric power detected by the user load electric power detecting means and based on the power generation output limit value EL.

Further, the first rap or calculation expression is made by deriving the power generation outputs of the fuel ell corresponding to the cooling capabilities of the radiator 77 at respective temperatures of the reserved hot water based on a second map or calculation expression which represents the correlation of the required cooing capabilities for the fuel cell system with the power generation outputs of the fuel cell at respective temperatures of the reserved hot water, and based on the cooling capability of the radiator 77 which is provided on the second heating medium circulation circuit 75, in which the second heating medium having collected the waste heat from the reformer 20 is circulated, for cooling the second heating medium. Therefore, since the power generation output limit value EL is derived based on the reserved hot water tank outlet temperature T4 and the cooling capability of the radiator 77, the power generation output of the fuel cell is determined also taking the cooling capability of the radiator 77 into account, and the balance between the power generation output and the utilization of the waste heat is kept in a better state, so that the operation of the fuel cell system can be performed efficiently while obviating the heat surplus state as far as possible.

Further since the cooling capability of the radiator 77 is the required cooling capability for the fuel cell system corresponding to the minimum power generation output of the fuel cell with the reserved hot water tank 71 filled up with the hot water, which capability is specified on the second ma, or calculation expression representing the correlation of the required cooling capability for the fuel cell system with the power generation output of the fuel cell at the maximum temperature Tₘₐₓ of the reserved hot water, it is possible to use the radiator 77 whose cooling capability is suppressed to a smaller one, and thus, it can be accomplished to make the radiator 77 compact and hence, the whole fuel cell system compact.

### 1b) Second Control Example

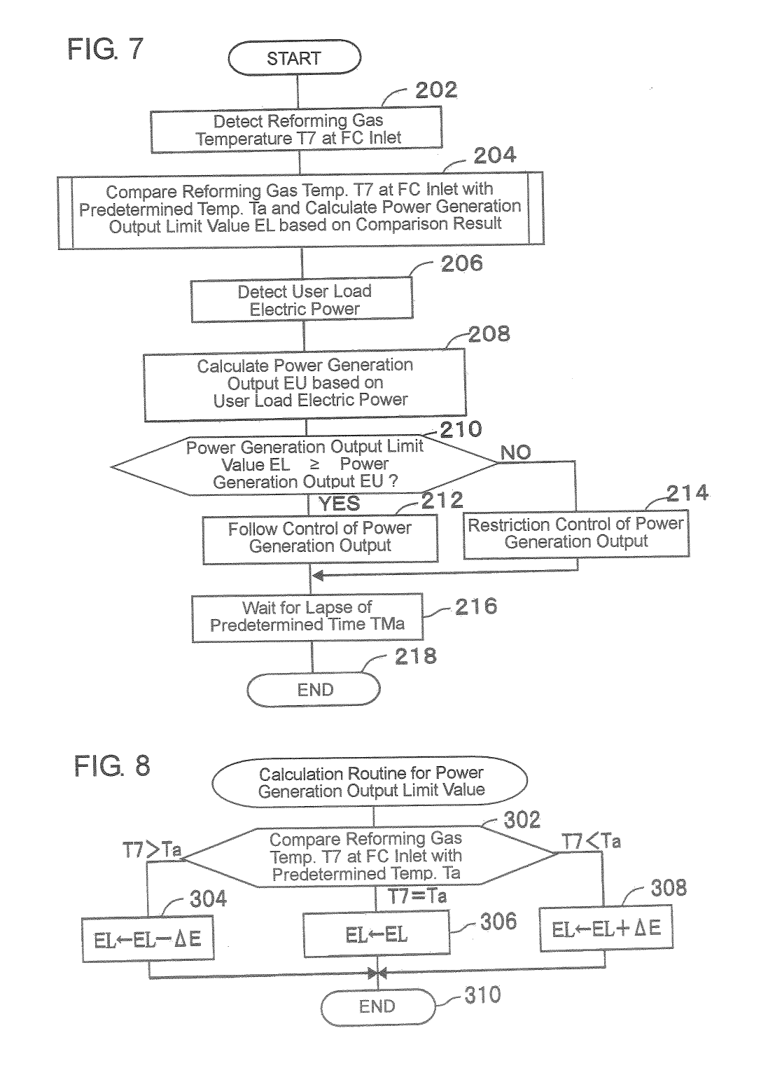

Hereafter, a second control example for the aforementioned fuel cell system will be described with reference to FIGS. 7 to 9. After turning a start switch (not shown) ON brings the fuel cell system into operation, there comes an ordinary operation capable of generating electric power upon completion of the start operation, and when the fuel gas FC inlet temperature T7 exceeds the predetermined temperature Ta, the control device 90 executes the program shown in FIG. 7 at predetermined short time intervals TMa. The control device 90 at step 202 detects the temperature (fuel gas FC inlet temperature) T7 of the fuel gas flowing the fuel pole inlet of the fuel cell 10, by the seventh temperature sensor 64a. Instead of the fuel gas FC inlet temperature T7, it may be possible to detect the temperature of one correlating with the fuel gas temperature T7, e.g., the condensing refrigerant temperature (condensing refrigerant reforming gas condenser outlet temperature) T3 at the outlet of the reforming gas condenser 31 by the third temperature sensor 75a. Then, the subsequent processing may be executed by the use of the detection value.

Then, at step 204, the fuel gas FC in et temperature T7 detected at step 202 is compared with a predetermined temperature Ta, and a power generation output limit value EL for the fuel cell 10 is derived based on the comparison result (second power generation output limit value deriving means). Specifically, the control device 90 executes a subroutine shown in FIG. 8. That is, the control device 90 calculates a present power generation output limit value EL-Δ by subtracting a predetermined amount ΔE from a preceding power generation output limit value EL when the temperature T7 detected at step 202 is greater than the predetermined temperature Ta (at steps 302 and 304), calculates the preceding power generation output limit value EL as the present power generation output limit value EL when the temperature T7 is equal to the predetermined temperature Ta (at steps 302 and 306) and calculates a present power generation output limit value EL+Δ by adding the predetermined amount ΔE to the preceding power generation output limit value EL when the temperature T7 is lower than the predetermined temperature Ta (at steps 302 and 308). Then, the control device 90 advances the program to step 310 to terminate the processing of the subroutine and then, to a processing at step 206 and those subsequent thereto. Although the fuel gas FC inlet temperature T7 detected at step 202 is compared with the predetermined temperature Ta at step 302, the comparison may be made between the fuel gas FC inlet temperature T7 and a predetermined temperature range (dead band).

Since the predetermined temperature Ta is determined to such a temperature that does not bring the fuel pole 11 of the fuel cell 10 into flooding, the fuel cell system can be operated stably by reliably preventing the power generation by the duel cell from being fallen down and stopped due to the flooding.

The control device 90 at steps 206-214 controls the power generation output of the fuel cell 10 based on the power generation output limit value EL derived by the second power generation output limit value deriving means (second power generation control means). Specifically, at step 206, the user load electric power is detected by the wattmeter 47a (user load electric power detecting means). At step 208, a power generation output EU of the fuel cell depending on the user load electric power detected at step 206 is derived by another map or calculation expression representing the correlation between the user load electric power and the power generation output (power generation output deriving means). At step 210, it is judged whether or not the power generation output limit value EL derived at step 204 is equal to or greater than the power generation output EU derived at step 208 (judgment means). At step 212; the power generation output of the fuel cell 10 is controlled to follow the user load electric power when the power generation output limit value EL is equal to or greater than the power generation output EU (follow control means). Further, at step 214, the power generation output of the fuel cell 10 is controlled to be restricted to the power generation output limit value EL when the power generation output limit value EL is less than the power generation output EU (restriction control means).

Then, the control device 90 waits for the lapse of a predetermined time TMa at step 216 while performing the follow control or the restriction control and then, advances the program to step 218 to terminate the program temporally. Thus, it results that the processing at step 202 and those next thereto is again executed after executing the control determined at step 212 or 214 for the predetermined time TMa.

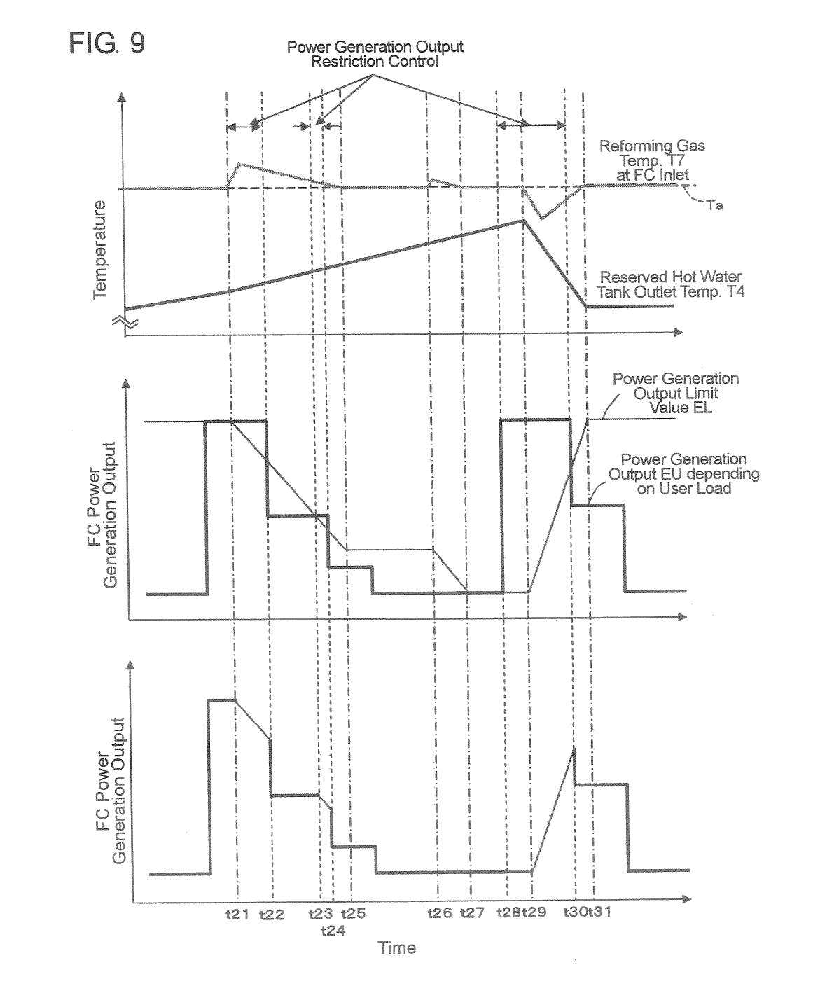

With this control, when the thermal energy accompanying the power generation by the fuel cell 10 upon the user de and causes the reserved hot water tank outlet temperature T4 to rise as shown at the top row in FIG. 9, the second heat exchanger 76 becomes unable to cool the condensing refrigerant, whereby the temperature of the condensing refrigerant rises. Together with this, the reforming gas FC inlet temperature T7 also begins to rise (time t21). It is assumed here that the reforming gas FC in let temperature T7 has been maintained at a predetermined temperature Ta until time t21 it is also assumed that until time t21, the fuel cell 10 has not been restricted in power generation output and has been able to produce electric power to the maximum power generation output.

When the reforming gas FC inlet temperature T7 becomes higher than the predetermined temperature Ta at time t2, the power generation output limit value EL becomes smaller gradually until the reforming gas FC inlet temperature T7 comes down again to the predetermined temperature Ta or lower (time t25), at the middle row in FIG. 9 (steps 202, 204, 302, 304, 310, 206-218). At the same time, whether to select the follow control or the restricted upon comparison of the power generation output limit value EL with the power generation output EU of the fuel cell depending on the user load electric power, and the selected control is executed. Since the follow control is also executed within the range that the power generation output limit value EL becomes smaller gradually, the power generation output (the maximum value of the power generation output) of the fuel cell 10 is suppressed in either case, whereby the heat generation from the fuel cell 10 is suppressed. Thus, the load on the radiator 77 becomes smaller, and the radiator 77 is able to cool the condensing refrigerant when it can afford to do, and hence, the reforming gas FC inlet temperature T7 can be lowered.

As a consequence, the reforming gas FC inlet temperature T7 reaches the predetermined temperature Ta at time t25. Where the power generation output EU depending on the user load electric power changes as shown at the middle row in FIG. 9 during the time period t21-t25, the power generation output is restricted to the power generation output limit value EL since the power generation output limit value EL is less than the power generation output EU during each of the periods t21-t22 and t23-t24. During other periods of time, because the power generation output limit value EL is equal to or greater than the power generation output EU, the follow control is performed, whereby the power generation output follows the user load electric power without being restricted (the bottom row in FIG. 9).

Further, the consumption of the reserved hot water or the like causes the reforming gas FC inlet temperature T7 to become less than the predetermined temperature Ta at the time t29, and the power generation output limit value EL is gradually increased until the reforming gas FC inlet temperature T7 goes up again to the predetermined temperature Ta or higher (time t31), as shown at the middle row in FIG. 9 (steps 202, 204, 302, 308, 310, 206-213). At the same time, whether to select the follow control or the restriction control is judged upon comparison of the power generation output limit value EL with the power generation output EU of the fuel cell depending on the user load electric power and the selected control is executed. Since the follow control is also executed within the range that the power generation output limit value EL becomes larger gradually, the power generation output (the maximum value of the power generation output) of the fuel cell 10 is increased in either case, whereby the heat generation from the fuel cell 10 is increased. Thus, it becomes possible to raise the temperature of the or de sing refrigerant and hence, to raise the reforming gas FC in et temperature T7.

As a consequence, the reforming gas FC inlet temperature TX reaches the predetermined temperature Ta at time t31. Where the power generation output EU depending on the user load electric power changes as shown at the middle row in FIG. 9 during the time period t29-t31, the power generation output is restricted to the power generation output limit value EL since the power generation output limit value EL is less than the power generation output EU during the period t29-t30. During other periods of time, since the power generation output limit value EL is equal to or greater than the power generation output EU, the follow control is performed, whereby the power generation output follows the user load electric power without being restricted (the bottom row in FIG. 9).

Therefore, according to the present second embodiment, the second power generation output limit value deriving means compares the fuel gas temperature TX at the fuel cell inlet detected by the seventh temperature sensor 64a or the temperature of one correlating with the fuel gas temperature with the predetermined temperature Ta and derives the power generation output limit value for the fuel cell based on the comparison result, and the second power generation control means controls the power generation output of the fuel cell 10 based on the power generation output limit value EL derived by the second power generation output limit value deriving means. Thus, during the power generation by the fuel cell 10, the reserved hot water is heated by collecting the waste heats which are generated from the fuel cell 10 and the reformer 20 with such power generation. However, when the reserved hot water tank 71 becomes filed up in the sense of temperature, the power generation output of the fuel cell 10 is restricted in dependence on the fuel gas temperature T7 at the fuel cell in et or the temperature of one correlating to the fuel gas temperature. Therefore, the heat generation from the fuel cell 10 can be suppressed as far as possible, and the balance is kept between the power generation output and the utilization of the waste heat so that the operation of the fuel cell system can be performed efficiently while obviating the heat surplus state as far as possible.

Further, the second power generation output limit value deriving means calculates the present power generation output limit value EL-ΔE by subtracting the predetermined amount ΔE from the preceding power generation output limit value EL when the fuel gas temperature T7 at the fuel cell inlet detected by the seventh temperature sensor 64a is greater than the predetermined temperature Ta, but calculates the present power generation output limit value EL+ΔE by adding the predetermined amount E to the preceding power generation output limit value EL when the fuel gas temperature T7 is less than the predetermined temperature Ta. Therefore, it is possible to calculate the power generation output limit value EL easily and reliably based on the fuel gas temperature T7 at the fuel cell inlet or the temperature of one correlating with the fuel gas temperature.

Further, in the second power generation control means, step 208 derives the power generation output of the fuel cell depending on the user load electric power detected at step 206, step 210 judges whether or not the power generation output limit value EL derived at step 204 is equal to or greater than the power generation output EU derived at step 208, step 212 controls the power generation output of the fuel cell 10 to follow the user load electric power when the power generation output limit value EL is judged at step 210 to be equal to or greater than the power generation output EU, and step 114 controls the power generation output of the fuel cell 10 to be restricted to the power generation output limit value EL when the power generation output limit value EL is judged at step 210 to be less than the power generation output EU. Thus, it can be realized to perform the stable operation of the fuel cell system simply and reliably based on the power generation output EU of the fuel cell depending on the user load electric power detected by the user load electric power detecting means and the power generation output limit value EL.

Further, each processing by the fuel gas fuel cell inlet temperature detecting means, the second power generation output limit value deriving means and the second power generation control means is repetitively executed at the interval of the predetermined time TMa which is set taking the responsiveness of the fuel gas into account so that the control processing can be executed at appropriate time. In addition, the control processing can be executed further precisely.

As clear from the foregoing description, in the present embodiment, the FC cooling water circulation circuit 73 being the first heating medium circulation circuit circulates the FC cooling water being the first heating medium which has collected the waste heat generated through the power generation by the fuel cell 10, and is provided independently of the reserved hot water circulation circuit 72 to perform the heat exchange between the reserved hot water and the first heating medium through the first heat exchanger 74. Further, the condensing refrigerant circulation circuit 75 being the second heating medium circulation circuit circulates the condensing refrigerant being the second heating medium which has collected at least either of the waste heat of the offgas exhausted from the fuel cell 10 and the waste heat generated in the reformer 20, and is provided independently of the reserved hot water circulation circuit 72 to perform the heat exchange between the reserved hot water and the second heating medium through the second heat exchanger 76. That is, the reserved hot water is not subjected to direct heat exchange with the anode offgas, the cathode offgas, the combustion exhaust gas and the reforming gas, but is subjected to indirect heat exchange through the second heat exchanger 76. Thus, where the reserved hot water tank 71 is a sealed type that has tap water replenished directly, the tap water pressure at a high pressure is applied to the reserved hot water tank 71 and the reserved hot water circulation circuit 72. However, since the second heating medium circulation circuit 75 is independent of the reserved hot water circulation circuit 72, the tap water pressure is not applied directly the respective condensers 31-34 which are the heat exchangers arranged on the second heating medium circulation circuit 75. Therefore, since the heat exchangers 31-34 are not required to take an excess pressure-resistive structure it can be realized to provide a fuel cell system which is capable of having water for the reserved hot water replenished from a high-pressure water source without inviting increases in cost and dimension.

Further, even if the reforming gas, the anode offgas, the cathode offgas and the combustion exhaust gas are mixed into the condensing medium being the second heating medium through the respective condensers 31, 32, 33, 34, they can be prevented from being mixed directly into the reserved hot water because the reserved hot water circulation circuit 72 is independent of the second heating medium circulation circuit 75. Further, even if it occurs that the reforming gas is mixed into the FC cooling water being the first heating medium through the fuel cell 10, the reforming gas can be prevented from being mixed directly into the reserved hot water because the reserved hot water circulation circuit 72 is independent of the first heating medium circulation circuit 73.

Further, since the second heating medium circulation circuit 75 is provided thereon with the respective condensers 31-34 for collecting heat from the high temperature, steam-impregnating gas which flows through the reformer 20 and the fuel cell 10 and for condensing the gas and since the second heating medium is the condensing refrigerant which flows through the condensers, the construction can utilize the existing one effectively without being enlarged in dimension, so that it becomes possible to raise the temperature of the second heating medium in a simplified structure and reliably.

Further, the reserved hot water circulation circuit 72 and the second heating medium circulation circuit 75 are respectively provided with the bypath passages 81, 84 for bypassing the second heat exchanger 76 and the flow path for the condensing medium can be selected from the second heat exchanger 76 and the bypath passage 84, while the flow path for the reserved hot water can be selected from the second heat exchanger 76 and the bypath passage 81. Thus, it becomes possible to selectively realize a case that the condensing refrigerant and the reserved hot water both flow through the second heat exchanger 76, another case that they flow respectively through the bypath passages 84, 81 and another case that the condensing refrigerant and the reserved hot water respectively flow through the second heat exchanger 76 and the bypath passage 84 or 81). Accordingly the heat exchange by the second heat exchanger 76 can be realized appropriately by selecting the passages for the fluids in dependence on the reserved hot water temperature or the like. Either one of the bypath passages 81, 84 may be provided so that the fluid flows through either of the second heat exchanger 76 and the bypass passage. Also with this the heat exchange by the second heat exchanger 76 can be realized appropriately in dependence on the reserved hot water temperature or the like.

In the foregoing embodiment, it is preferable to provide at least any one of the reserved hot water circulation circuit 72 and the first heating medium circulation circuit 73 with a bypass passage for bypassing the first heat exchanger 74, in the same manner that any one of the reserved hot water circulation circuit 2 and the second heating medium circulation circuit 75 is provided with the bypass passage for bypassing the second heat exchanger 76. Also with this, the heat exchange by the first heat exchanger can be realized appropriately by selecting the flow passages for the fluid in dependence on the reserved hot water temperature or the like.

Further, although in the foregoing embodiment, the FC cooling water circulation circuit 73 condensing refrigerant circulation circuit 75 are provided independently of each other, the both circuits 73, 75 may be configured to be a single circulation circuit (heating medium circulation circuit). In this case, the heating medium circulation circuit is to be of the configuration that it is provided independently of the reserved hot water circulation circuit 72 for circulating the heat medium having collected the waste heats from the fuel cell 10 and the reformer 20. In addition, the heat exchanger for performing heat exchange between the reserved hot water and the heating medium is provided over the heating medium circulation circuit and the reserved hot water circulation circuit 72. That is, the heating medium circulation circuit has arranged thereon the fuel cell 10 and the respective condensers 31-34.

Also with this, the heating medium circulation circuit circulates the heating medium having collected the waste heats from the fuel cell 10 and the reformer 20, is provided independently of the reserved hot water circulation circuit 72, and performs the heat exchange between the reserved hot water and the heating medium through the heat exchanger. That is, the reserved hot water is not subjected to direct heat exchange with the anode offgas, the cathode offgas, the combustion exhaust gas and the reforming gas, but is subjected to indirect heat exchange through the heat exchanger. Thus, where the reserved hot water tank is a sealed type that has tap water replenished directly, the tap water pressure at a high pressure is applied to the reserved hot water tank 71 and the reserved hot water circulation circuit 72. However, since the heating medium circulation circuit is independent of the reserved hot water circulation circuit 72, the tap water pressure is not applied directly to the heal exchangers which are arranged on the heating medium circulation circuit for heat exchanges with the anode offgas, the cathode offgas, the combustion exhaust gas and the reforming gas. Therefore, since the exchangers are not required to take an excess pressure-resistive structure, it can be realized to provide a fuel cell system which is capable of having water for the reserved hot water replenished from a high-pressure water source without inviting increases in cost and dimension.

Also in this case, it is preferable that at least any one of the reserved hot water circulation circuit 72 and the heating medium circulation circuit is provided with the radiator 77 being the cooler means for cooling fluid. With this construction, where the reserved hot water temperature reaches the temperature required for the fuel cell or the temperature required for the condensing refrigerant having collected the waste heat from the reformer 20, it becomes possible to efficiently cool the reserved hot water or/and the heating medium by the cooler means in order that the reserved hot water does not further rise in temperature by collecting the waste heat.

Further, in this case, it is preferable to provide any one of the reserved hot water circulation circuit 72 and the heating medium circulation circuit with a bypass passage for bypassing the heat exchanger, in the same manner that any one of the reserved hot water circulation circuit 72 and the second heating medium circulation circuit 75 is provided with the bypass passage for bypassing the second heat exchanger 76. Also with this, the heat exchange by the heat exchanger can be realized appropriately by selecting the flow passage for the fluid in dependence on the reserved hot water temperature or the like.

### INDUSTRIAL APPLICABILITY

As described above, the fuel cell system according to the present invention is suitable for use in the case that water for the reserved hot water is to be replenished from a high-pressure water source without inviting increases in cost and dimension.

1-18. (canceled)

19. A fuel cell system comprising:
a fuel cell;
a reformer for generating fuel gas to be supplied to the fuel cell,
a reserved hot water tank for storing reserved hot water replenished from a high pressure water source, and
a reserved hot water circulation circuit for circulating the reserved hot water;
wherein waste heats generated in the fuel cell and the reformer are collected on the reserved hot water circulation circuit to heat the reserved hot water the system further comprising:
a first heating medium circulation circuit provided independently of the reserved hot water circulation circuit for circulating a first heating medium which has collected the waste heat generated through the power generation by the fuel cell;
a second heating medium circulation circuit provided independently of the reserved hot water circulation circuit and the first heating medium circulation circuit for circulating a second heating medium which has collected at least either the waste heat of offgas exhausted from the fuel cell or the waste heat generated in the reformer;
a first heat exchanger for performing heat exchange between the reserved hot water and the first heating medium; and
a second heat exchanger for performing heat exchange between the reserved hot water and the second heating medium.

20. The fuel cell system in claim 19, wherein at least any one circulation circuit of the reserved hot water circulation circuit, the first heating medium circulation circuit, and the second heating medium circulation circuit includes cooler means for cooling fluid.

21. The fuel cell system in claim 19, wherein at least any one circulation circuit of the reserved hot water circulation circuit, the first heating medium circulation circuit, and the second heating medium circulation circuit includes a bypass passage for bypassing the heat exchanger associated therewith.

22. The fuel cell system in claim 19, wherein the second heating medium circulation circuit includes thereon a condenser for collecting heat from high temperature, steam-impregnating gas which circulates through any one of the reformer and the fuel cell, and for condensing the steam; and wherein the second heating medium is condensing refrigerant which circulates through the condenser.

23. The fuel cell system in claim 19, further comprising:
reserved hot water tank outlet temperature detecting means provided on the reserved hot water circulation circuit for detecting the temperature of the reserved hot water outflowing from an outlet of the reserved hot water tank;
first power generation output limit value deriving means for deriving a power generation output limit value based on the reserved hot water tank outlet temperature detected by the reserved hot water tank outlet temperature detecting means and a first map or calculation expression representing the correlation between the reserved hot water tank outlet temperature and the power generation output limit value for the fuel cell; and
first power generation control means for controlling the power generation output of the fuel cell in dependence on the power generation output limit value derived by the first power generation output limit value deriving means.

24. The fuel cell system in claim 23, wherein the first power generation control means comprises:
user load electric power detecting means for detecting a user load electric power;
power generation output deriving means for deriving a power generation output of the fuel cell depending on the user load electric power detected by the user load electric power detecting means;
judgment means for judging whether or not the power generation output limit value derived by the first power generation output limit value deriving means is equal to or greater than the power generation output derived by the power generation output deriving means; and
restriction control means for restricting the power generation output of the fuel cell to the power generation output limit value when the power generation output limit value is judged by the judgment means to be less than the power generation output.

25. The fuel cell system in claim 23, further comprising:
cooler means provided on the second heating medium circulation circuit for cooling the second heating medium;
wherein the first map or calculation expression is made by deriving the power generation outputs of the fuel cell corresponding to cooling capabilities of the cooler means at respective temperatures of the reserved hot water based on a second map or calculation expression representing the correlation of required cooling capabilities for the fuel cell system with power generation outputs of the fuel cell at respective temperatures of the reserved hot water and based on a cooling capability of the cooler means.

26. The fuel cell system in claim 25, wherein the cooling capability of the cooler means is specified by a required cooling capability for the fuel cell system corresponding to the minimum power generation output of the fuel cell with the reserved hot water tank filled up with the hot water, based on the second map or calculation expression representing the correlation of a required cooling capability for the fuel cell system with the power generation output of the fuel cell at the maximum temperature of the reserved hot water.

27. The fuel cell system in claim 19, wherein:
the second heating medium circulation circuit includes a condenser for condensing steam from reforming gas which is supplied from the reformer to the fuel cell;
the system further comprising:
fuel gas fuel cell inlet temperature detecting means for detecting the temperature of the fuel gas inflowing to the inlet of the fuel cell or the temperature of one correlating with the temperature of the fuel gas;
second power generation output limit value deriving means for comparing the temperature detected by the fuel gas fuel cell inlet temperature detecting means with a predetermined temperature and for deriving a power generation output limit value for the fuel cell based on the comparison result; and
second power generation control means for controlling the power generation output of the fuel cell based on the power generation output limit value derived by the second power generation output limit value deriving means.

28. The fuel cell system in claim 27, wherein the second power generation output limit value deriving means calculates a present power generation output limit value by subtracting a predetermined amount from a preceding power generation output limit value when the temperature is over the predetermined temperature but calculates the present power generation output limit value by adding the predetermined amount to the preceding power generation output limit value when the temperature is under the predetermined temperature.

29. The fuel cell system in claim 27, wherein the second power generation control means comprises:
user load electric power detecting means for detecting a user load electric power;
power generation output deriving means for deriving the power generation output of the fuel cell in dependence on the user load electric power detected by the user load electric power detecting means;
judgment means for judging whether or not the power generation output limit value derived by the second power generation output limit value deriving means is equal to or greater than the power generation output derived by the power generation output deriving means; and
restriction control means for controlling the power generation output of the fuel cell to be restricted to the power generation output limit value when the power generation output limit value is judged by the judgment means to be less than the power generation output.

30. A fuel cell system comprising:
a fuel cell;
a reformer for generating fuel gas to be supplied to the fuel cell;
a reserved hot water tank for storing reserved hot water; and
a reserved hot water circulation circuit for circulating the reserved hot water;
wherein waste heats generated in the fuel cell and the reformer are collected on the reserved hot water circulation circuit to heat the reserved hot water, the system further comprising:
a heating medium circulation circuit provided independently of the reserved hot water circulation circuit for circulating heating medium which has collected at least either of the waste heat of offgas exhausted from the fuel cell or the waste heat generated in the reformer and the waste heat generated through the power generation by the fuel cell;
a heat exchanger for performing heat exchange between the reserved hot water and the heating medium;
a condenser provided on the heating medium circulation circuit for collecting heat from high temperature, steam-impregnating gas which circulates through either one of the reformer and the fuel cell and for condensing the steam; and
cooler means provided on the heating medium circulation circuit on which the condenser is provided, for cooling the heating medium circulating through the heating medium circulation circuit.

31. The fuel cell system in claim 30, further comprising:
reserved hot water tank outlet temperature detecting means provided on the reserved hot water circulation circuit for detecting the temperature of the reserved hot water outflowing from an outlet of the reserved hot water tank;
first power generation output limit value deriving means for deriving a power generation output limit value based on the reserved hot water tank outlet temperature detected by the reserved hot water tank outlet temperature detecting means and a first map or calculation expression representing the correlation between the reserved hot water tank outlet temperature and the power generation output limit value for the fuel cell; and
first power generation control means for controlling the power generation output of the fuel cell in dependence on the power generation output limit value derived by the first power generation output limit value deriving means.

32. The fuel cell system in claim 31, wherein the first power generation control means comprises:
user load electric power detecting means for detecting a user load electric power;
power generation output deriving means for deriving a power generation output of the fuel cell depending on the user load electric power detected by the user load electric power detecting means;
judgment means for judging whether or not the power generation output limit value derived by the first power generation output limit value deriving means is equal to or greater than the power generation output derived by the power generation output deriving means; and
restriction control means for controlling the power generation output of the fuel cell to be restricted to the power generation output limit value when the power generation output limit value is judged by the judgment means to be less than the power generation output.

33. The fuel cell system in claim 31, wherein:
the first map or calculation expression is made by deriving the power generation outputs of the fuel cell corresponding to cooling capabilities of the cooler means at respective temperatures of the reserved hot water based on a second map or calculation expression representing the correlation of required cooling capabilities for the fuel cell system with power generation outputs of the fuel cell at respective temperatures of the reserved hot water and based on a cooling capability of the cooler means.

34. The fuel cell system in claim 33, wherein the cooling capability of the cooler means is specified by a required cooling capability for the fuel cell system corresponding to the minimum power generation output of the fuel cell with the reserved hot water tank filled up with the hot water, based on the second map or calculation expression representing the correlation of a required cooling capability for the fuel cell system with the power generation output of the fuel cell at the maximum temperature of the reserved hot water.

35. The fuel cell system in claim 30, wherein:
the heating medium circulation circuit includes thereon a condenser for condensing steam from reforming gas which is supplied from the reformer to the fuel cell;
the system further comprising:
fuel gas fuel cell inlet temperature detecting means for detecting the temperature of the fuel gas inflowing to an inlet of the fuel cell or the temperature of one correlating with the temperature of the fuel gas;
second power generation output limit value deriving means for comparing the temperature detected by the fuel gas fuel cell inlet temperature detecting means with a predetermined temperature and for deriving a power generation output limit value for the fuel cell based on the comparison result; and
second power generation control means for controlling the power generation output of the fuel cell based on the power generation output limit value derived by the second power generation output limit value deriving means.

36. The fuel cell system in claim 35, wherein the second power generation output limit value deriving means calculates a present power generation output limit value by subtracting a predetermined amount from a preceding power generation output limit value when the temperature is over the predetermined temperature, but calculates the present power generation output limit value by adding the predetermined amount to the preceding power generation output limit value when the temperature is under the predetermined temperature.

37. The fuel cell system in claim 35 wherein the second power generation control means comprises:
user load electric power detecting means for detecting a user load electric power;
power generation output deriving means for deriving a power generation output of the fuel cell depending on the user load electric power detected by the user load electric power detecting means;
judgment means for judging whether or not the power generation output limit value derived by the second power generation output limit value deriving means is equal to or greater than the power generation output derived by the power generation output deriving means; and
restriction control means for controlling the power generation output of the fuel cell to be restricted to the power generation output limit value when the power generation output limit value is judged by the judgment means to be less than the power generation output.
